(19) United States
(12) Patent Application Publication
(10) Pub. No.: US 2013/0041593 A1
(43) Pub. Date: Feb. 14, 2013

(54) Method for fast and accurate alignment of sequences

(71) Applicant: Vitaly L GALINSKY, San Diego, CA (US)

(72) Inventor: Vitaly L GALINSKY, San Diego, CA (US)

(21) Appl. No.: 13/545,077

(22) Filed: Jul. 10, 2012

Related U.S. Application Data
(60) Provisional application No. 61/522,853, filed on Aug. 12, 2011.

(51) Int. Cl. G06F 19/16

(52) U.S. Cl. 702/20

(57) ABSTRACT

Genomic sequence matching and alignment techniques are disclosed. In one embodiment of the invention, computerized methods are provided for analyzing sequence similarity data obtained by means of a table of all local hits recorded between query sequence and reference index. The table of local hits represents all occurrences of query subsequences in reference index that stored all transitions between single l-mer prefix to multiple m-mer suffixes. The index data structure may take a variety of forms, including an array or a tree. The base position of each transition from l-prefix to m-suffix is recorded in k-bit masked form. The positions data structure may take a variety of forms as well, including an array or a tree. The table of local hits derived from l-prefix, m-suffix and k-position reference index is used by a series of low time and space complexity algorithms for optimizing alignment between query and reference.

The current application claims a priority to the U.S. Provisional Patent application Ser. No. 61/522,853 filed on Aug. 12, 2011.

### FIELD OF THE INVENTION

The present invention relates to the comparison of biological sequences and, more specifically, the invention relates to a method, a computer readable device, and an electronic device for fast and accurate alignment of sequences using local hit tables for rapid screening of local sequence similarity in accordance with the claims.

### BACKGROUND OF THE INVENTION

It is frequently desired to compare two sequences for the purpose of determining similar portions of these sequences. Searching databases for sequences similar to a given sequence is probably one of the most fundamental and important tools for predicting structural variations and functional properties in the modern biology.

The rapidly increasing amounts of genetic sequence information available represent a constant challenge to developers of hardware and software database searching and handling. The expansion of an amount of the genetic sequence information happens at a rate that exceeds the growth in computing power available at a constant cost, in spite of the fact that computing resources also have been increasing exponentially for many years. If this trend continues, increasingly longer time or increasingly more expensive computers will be needed to search the entire database.

Searching for similarity includes introducing “gaps” into a query sequence, a reference sequence, or both sequences that optimize the amount of similarity. When looking for sequences in a database similar to a given query sequence, the search programs compare the query sequence (with unknown distribution of gaps) to every subsequence in the database (again with unknown distribution of gaps). The availability of good tools for fast and accurate alignment of query sequences to database is hence extremely important.

The typical current approach for similarity search and alignment is based on calculating alignment scores of the two sequences using a substitution score matrix and a gap penalty function. A dynamic programming algorithm for computing the optimal local alignment was first described by Smith and Waterman (1981). See T. F. Smith and M. S. Waterman, Identification of Common Molecular Subsequences, J. Mol. Bioi. (1981) 147, 195-97. Sequence matching is commonly performed on very long sequences, and the currently emerging single molecule sequencing technologies are constantly pushing read lengths into longer and longer realm, with 100 K or 1 M base pairs queries are not a fantasy. Performing matching of such sequences using the Smith-Waterman algorithm (SW) is very computationally intensive—on the order of M×N operations (denoted as “O(MN)” complexity), where M and N are the lengths of the two sequences being matched. As a result, the use of the Smith-Waterman algorithm is not practical in many instances. A less computationally intensive method for sequence matching is therefore desired.

U.S. Pat. No. 7,917,302 B2 (Rogues) discloses a method for an efficient parallelization of the Smith-Waterman sequence alignment algorithm using parallel processing in the form of SIMD (Single-Instruction, Multiple-Data) technology. The method still has O(MN) complexity both in time and in space, and hence, not practical for high throughput applications.

U.S. Pat. No. 2009/0125514 A1 (Brown) discloses sequence alignment techniques that introduce a sparse data structure for the Smith-Waterman matrix. This method provides logarithmic improvement for the time complexity O((M+N)log(M)), and because typically

N [symbol] M that method may still be not sufficient for large sequence databases. For example, for human genomic sequence alignment with N being more than 3 billion characters and M=100, the improvement is about 100/log(100)=21.7, but at the expense of losing some of the true alignments.

“Fast and accurate long-read alignment with Burrows-Wheeler transform” (Li, H. and Durbin, R.) discloses a Burrows-Wheeler Aligner's Smith-Waterman Alignment (BWA-SW) method to align long sequences against a large sequence database (e.g. the human genome). The method adds several heuristics accelerations to the Smith-Waterman algorithm and is able to reduce the time complexity of the algorithm to the sub quadratic level O(N^{0.628}M) and again at the expense of losing some of the true alignments.

U.S. Patent Application No. 61/521,454, Unpublished (filing date Aug. 9, 2011) (Vitaly Galinsky, applicant) discloses techniques for rapid similarity screening between sequences that do not rely on the Smith-Waterman dynamic programming techniques. The method constructs a table of local similarity hits between query and reference sequences and allows to deduce number, size, and type of gaps present in query sequence but do not specify their exact locations. Nevertheless, this method provides improvement for the time complexity O(M), where M is the size of the query sequence.

Accordingly, what is desired, and not heretofore been developed, is a writing alignment tool wherein the total time complexity would be reduced and completely independent from the large size of the reference database. Furthermore, what is desired, and not heretofore been developed, is a writing alignment tool that allows not only rapid assessment of a similarity between genomic sequences but accurately finds all differences between query and reference, including positions of all gaps, in a linear time O(M).

### BRIEF SUMMARY OF THE INVENTION

This invention is related to bioinformatics and biological data analysis. Specifically, this invention provides methods, computer software products, and systems for fast and accurate alignment of sequences that follows a step of rapid assessment of similarity between genomic (DNA or RNA) sequences. In preferred embodiments, the methods, computer software products, and systems are used for high throughput processing of vast amount of genomic reads (queries) against very large genomic database (reference), which is aligning queries to the reference.

In preferred embodiments, methods are provided for analyzing the results of the sequential processing of the genomic query against the reference database by means of building of local hit table that includes positions of all similarities between each query subsequence (l base pairs prefix and m base pairs suffix) in the reference database and by merging the local hits in the table that correspond to the same alignment and obtaining gaps and structural variations data in the merging process. The time complexity of local hit table building provided by preferred embodiments depends linearly on the size of the query.

In some preferred embodiments, the methods include using gap size and type data from the merging process in local hit table for further fast and accurate optimization of similarity between query and reference to obtain exact gap locations and/or structural variations present in query.

In another aspect of the invention, systems and computer software are provided for performing the methods of the invention. The systems include a processor; and a memory coupled with the processor, the memory storing a plurality of machine instructions that cause the processor to perform logical steps of the methods of the invention. The computer software products of the invention include a computer readable medium having computer-executable instructions for performing the method of the invention.

### BRIEF DESCRIPTION OF THE DRAWINGS

FIG. 1 illustrates a typical index used in a new approach. The arrows indicate the index direction in transition from l base pairs prefix to m base pairs suffix, forward being left to right and backward being right to left. Tables at each transition contain all recorded positions in the reference sequence with dark bold corresponding to k-bit masked part. Current position is underlined.

FIG. 2 illustrates a query processing step and a building of a table of local hits between query and reference for a query with several base pairs gap.

FIG. 3 illustrates pseudo-code for the query processing step of the approach, the pseudo-code being just a detailed example showing how the method may be implemented in a computer program.

FIG. 4 illustrates an alignment step that uses gap size and type deduced by analysis of a local hit table to further optimize the similarity between query and reference database.

FIG. 5 illustrates pseudo-code for alignment step that applies gap information obtained from table of local hits.

FIG. 6 illustrates an example of a computer system that may be used to execute the software of an embodiment of the invention.

FIG. 7 illustrates one embodiment of internal composition of a computer system that may be used to implement the above-described methods.

### DETAILED DESCRIPTION OF THE INVENTION

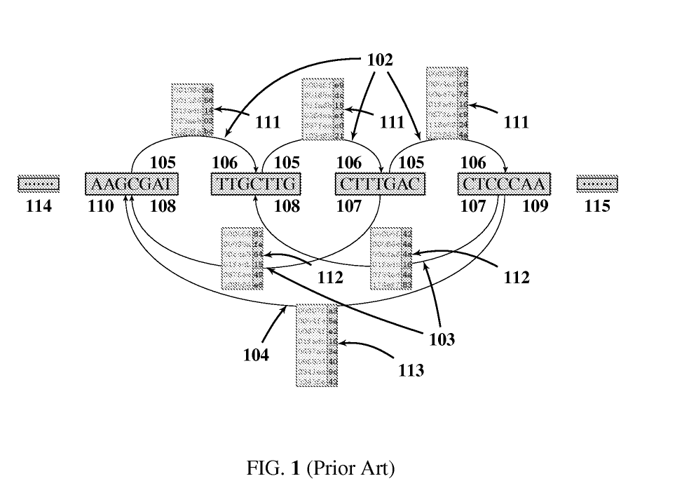

The preferred embodiment will be described with reference to the drawings. The method uses prior art forward 102 and backward indices (103, 104) for the reference sequence as shown in FIG. 1. The indices are organized in list type structures to combine the advantages of both hash based and trie based methods. FIG. 1 shows the schematic diagram of an intermediate single step of index building, ignoring leading 114 and trailing 115 parts of the reference sequence. The forward index 102, shown above the sequence, is organized as a lexicographically sorted array of l base pairs prefixes 105. Each prefix entry 105 is pointing to a a lexicographically sorted array of m base pairs suffixes 106, as shown by left to right directed arrows 102. In turn each suffix entry 106 is associated with a numerically sorted array of l scaled k-bit masked locations 111 (i.e. locations/l modulo 2^{k}) of each of these l+m base pairs indexed entries, as shown by tables touching the arrows 111. An optimal choice of l, m, k parameters probably depends on a size and a composition of reference sequence, but for human genome with around 3 billion base pairs the parameters l=m=7 base pairs and k=8 bit seem to work rather well and were adopted as a feasibility checkpoint in all the results reported below using test implementation of this paper. Size of this index for the human genome is roughly 3 billions base pairs/7 base pairs×8 bit≈400 MB.

The purpose of splitting l+m bp indices into l-bp prefix and m-bp suffix is not just for conserving memory. Both the prefix and the suffix parts are lexicographically sorted, therefore, they provide not only an index (or hash), but also can work as a forward or backward tree, thus allow fast unwinding of low complexity/low error rate regions. An adaptation of k=8 bit mask to store the locations naturally creates compressed index, as many highly repetitive parts of the reference will be collapsed into a single index entry with the same prefix, suffix and masked location.

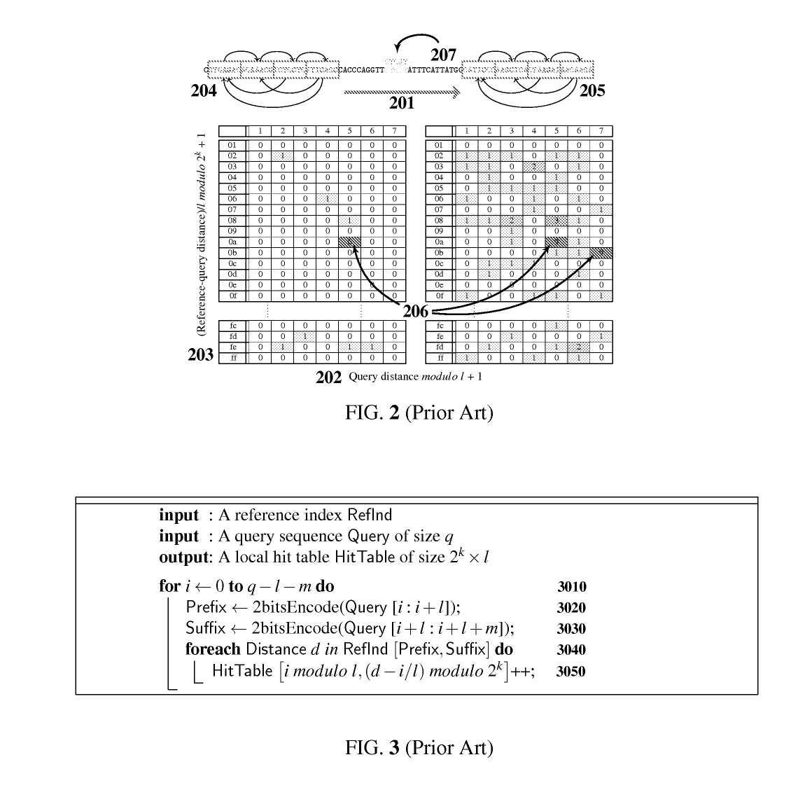

FIG. 2 shows the process of finding all local similarities 201 between a query and a reference sequence, that starts with recording of all local hits between them. The hits are organized in a table by a distance in a query (modulo l) 202 versus a difference in distances in a reference and in a query (scaled by l and modulo 2^{k}) 203. A size of this table depends on the choice of parameters l, m and k and can be expressed as l×2^{k}, where 7×256 table is shown in FIG. 2. Two states of the local hit table are shown: at the beginning 204 and the end 205 of processing of the query sequence. The cells with the highest numbers 206 correspond to significant similarities between query and reference. The second table (not shown) is filled up for the reverse compliment query sequence.

The entries with highest number of hits 206 will be candidates for the best alignment of the query to the reference. Presence of single well separated maximum in the hit table clearly indicates the unique alignment. For a set of chosen parameters (l=m=7 and k=8) a difference of 4 or 5 between max and second max entries in the hit table is good enough to rule out random hits that may arise due to rather short period of the l-scaled 2^{k}-masked location for k=8.

Construction of full local hit table 201 for the query sequence creates rather convenient and straight forward way of searching for significant alignments with small but arbitrary gaps 207 as well as for detection of chimeric reads. At the final stage 205, these gaps leave distinct signatures in local hit table. For example, for a single 5 base pairs deletion 207, the leading and the trailing portions of the sequence (roughly of 40 base pairs each in illustration of FIG. 2) will produce two maximums with 3·((40−40 mod 7)/7−4)+6=9 hits 206 separated by 4 consecutive cells without hits or with low random hit counts.

Presence in the query sequence highly repetitive areas may complicate the search, especially when combined with errors, single-nucleotide polymorphisms (SNPs), or insertions/deletions. But input from repetitive regions tends to spread uniformly across many hit table entries and won't destroy the input from unique regions. Hence, the local hit table provides easy way of finding the total size of gap or gaps between local subalignments as well as types of these gaps (insertion or deletion) by analyzing the maximums that were formed at different 2k -masked locations. In general, n bases deletion produces n-1 empty cells in the right-left and then top-down direction with respect to the original cell. On the contrary, n bases insertion does it in the reverse, it adds n-1 empty/low noise cells in the left-right down-top direction. Thus, the local hit table provides easy way of finding the total size of gap or gaps between local subalignments as well as types of these gaps (insertion or deletion) by analyzing the maximums that were formed at different 2^{k}-masked locations. For chimeric read the hit table will contain several maximums as well but the separation between them both by the 2^{k}-masked location and by the full distance may in general be arbitrary large.

FIG. 3 shows a pseudo-code of the local hit table building step, that includes a loop over a query sequence 3010, to extract l+m base pairs subsequences. Each subsequence split in binary encoded (2 bitsEncode) l base pairs prefix 3020 and m base pairs suffix 3030 and their values are used to retrieve numerically sorted array of l scaled k-bit masked reference locations 3040. This location array is used to update values in local hit table 3050. Size of this location array is 2^{k} and, therefore, the time complexity of the algorithm is O(2^{k} q) , where q is the length of the query, i.e. for k=8 it is O(256q).

One of the most important differences of presented method from the majority of long read alignment methods lies in the dismissal of seed-and-extend paradigm that is routinely employed by the most of current long read aligners. The existing algorithms (both hash and trie based) first search for the alignment seeds, but limit their number or size and usually keep several non overlapped 11-12 bp fixed size seeds or one 25-35 bp variable size (possibly with gaps) seed as candidates for further processing. Their next step involves extending seed alignments to the rest of the query sequence using the dynamic programming approaches, usually the Smith-Waterman algorithm. Giving the remaining length of the query q and the size of the part of the reference used for alignment r=q+g (allowing for possible gap or gaps of the total length g) the typical time complexity of this dynamic programming step is O(qr)=O(q²+gq).

Instead of extending relatively short seed area to the entire query sequence with this expensive (quadratic in time) dynamic programming step, the presented invention develops different strategy, which scales linearly O(q) with the size of the query q.

When the entire query sequence has been processed and candidate entries from the hit table for the final alignment have been identified the last processing step involves decoding the unmasked location of the hits in the reference (may be resolving collisions due to finite period of 2^{k} masked location if present in the hits) and glueing those hits together.

Because of the presence of single or multiple base errors, SNPs, or insertions/deletions, there will be areas in the query sequence where no local hits are detected, thus the glueing stage should provide a way of filling all these holes. When the hole is surrounded by the local hits with the same difference between the query and the reference coordinates, the filling is of course trivial and involves simple O(n) (n is the length of the hole, n [symbol] q) transition through all bases in the hole in order to find and record all mismatches. Of course, theoretically it may be possible that adding equal number of equal length insertions and deletions may lower the total score, practically it is highly unlikely, giving the relatively high gap penalty used in most current algorithms and small size of the holes, especially in resequencing as well as in long read de novo assembly projects.

The major advantage of the algorithm emerges when the hole is located in the area between local hits with different values of the query and the reference coordinate differences (as shown in example in FIG. 2). This indicates that gap (either insertion or deletion) should be introduced somewhere in the hole to allow the transition from the leftmost to the rightmost hits. As it was shown above, the local hit table allows deducing the total size as well as the type of the gap, but the exact position of this gap (or gaps) in the query sequence relative to the reference still needs to be determined.

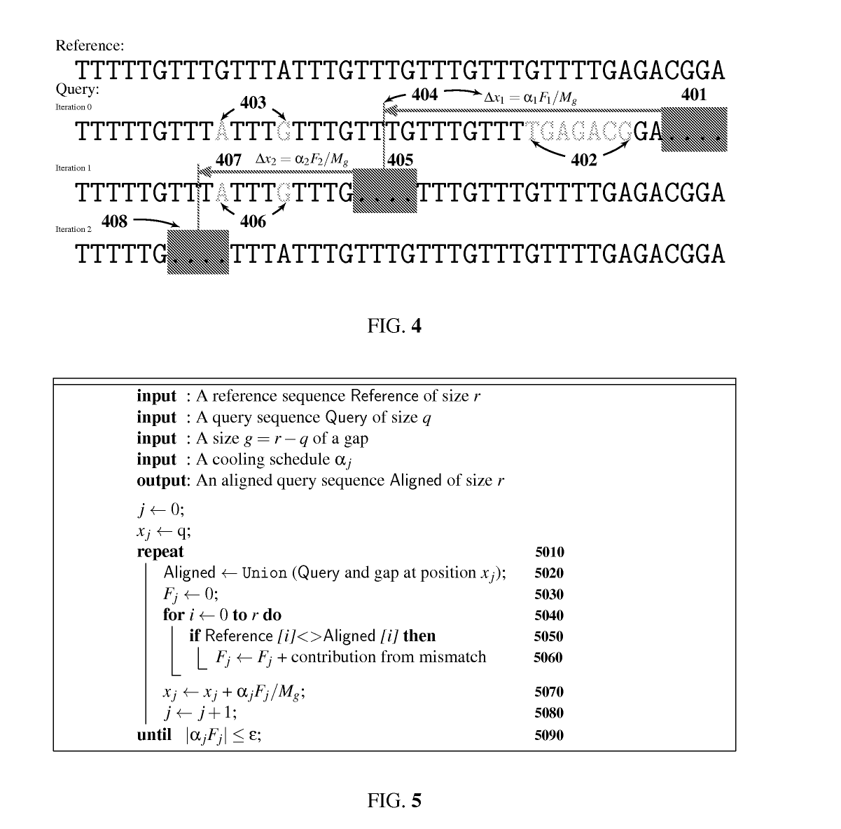

The approach is illustrated in simplistic form in Figure FIG. 4 using a query sequence from chromosome 1. The illustration shows how the exact position of g=4 by gap (deletion) in the query sequence can be found using simulated annealing type algorithm with O(n) time complexity (similar strategy can be applied to find a position of insertion by placing the gap in the reference instead). This simplistic illustration shows how O(n) procedure can be used as an efficient alternative to O(n²+gn) Smith-Waterman algorithm when the general info about gaps is obtained by another approach (local hit table in this case). The procedure uses gap size g and type (deletion) obtained from the local hit table and finds the gap position iteratively using some cooling schedule (αᵢ), gap/mismatch interaction potential/force (Fᵢ) and virtual gap mass (M_{g}).

The gap that is inserted initially at an arbitrary position in the hole region of the query 401 and is assumed to be able to move freely anywhere in the region. Its position is updated under an influence of attractive force 404 acting on the gap from each mismatch site in the region, either clamped 402 or individually separated 403. A new position of the gap 405 is determined using some effective gap mass (M_{g}) and cooling schedule (αᵢ). On the following iteration different (usually smaller) number of mismatches 406 will give rise to the attractive force 407 ultimately resulting in a final (optimal) position of the gap 408 after several iterations. The final gap position may be not unique, but in general this iterative procedure has O(n) time complexity for finding an optimal gap location.

The performance (i.e. rate of convergence) of simulated annealing type optimization is implementation dependent and can be controlled or fine tuned by changing various parameters, e.g. annealing (cooling) schedule (i.e. the rate and the pattern of increase or decrease in the mobility of the gap with respect to the same applied force), type of gap/mismatch interaction potential (e.g. dependence of the force on the gap/mismatch separation), effective gap mass and so on.

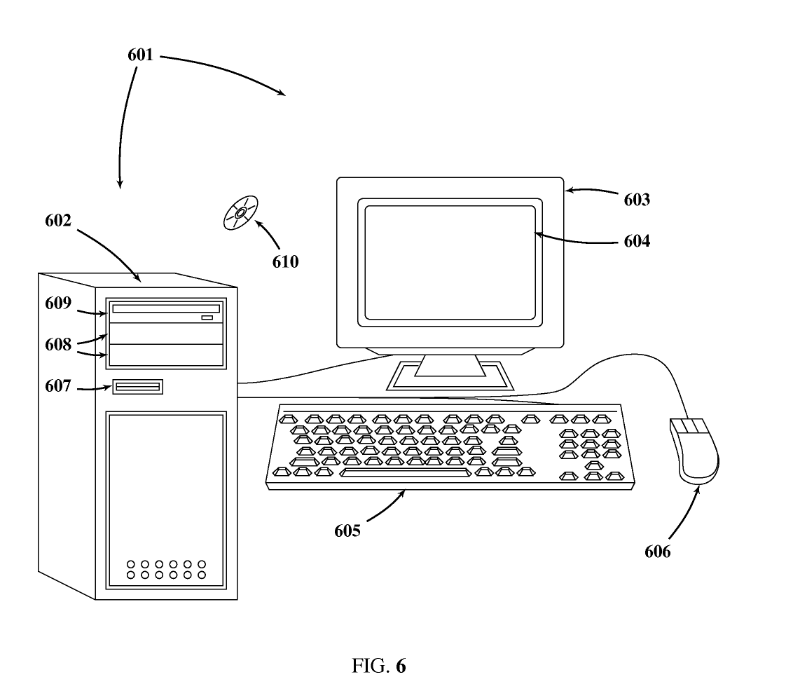

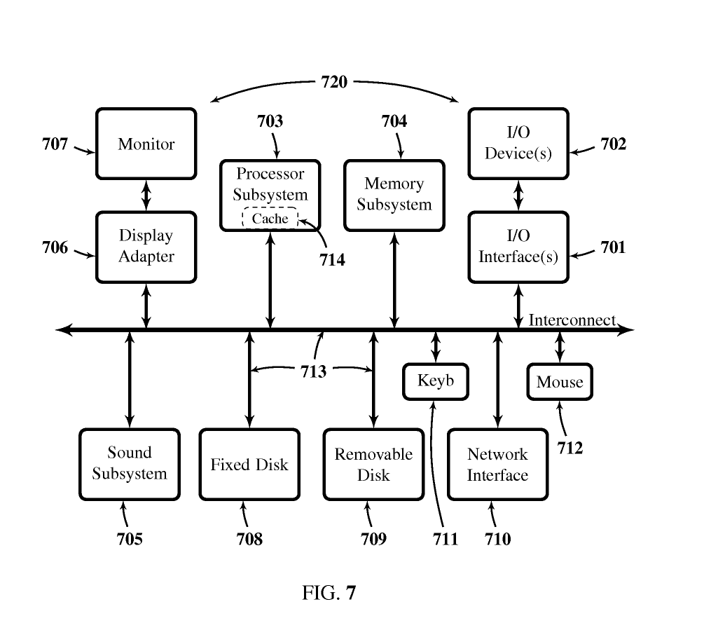

FIG. 6 illustrates an example of a computer system that may be used to execute the software of an embodiment of the invention. FIG. 6 shows a computer system 601 that includes a system block 602, display 603, screen 604, keyboard 605, and mouse 606. Mouse 606 may have one or more buttons for interacting with a graphic user interface. System block 602 houses a floppy drive 607, CD-ROM, DVD-ROM or BD- ROM drive 609, system memory and a hard drive 608 (see also FIG. 7) which may be utilized to store and retrieve software programs incorporating computer code that implements the invention, data for use with the invention and the like. Although a CD 610 is shown as an exemplary computer readable medium, other computer readable storage media including floppy disk, tape, flash memory, system memory, and hard drive may be utilized. Additionally, a data signal embodied in a carrier wave (e.g., in a network including the Internet) may be the computer readable storage medium.

The sequence assessment embodiments described above may be performed on any suitable type of computer system, which includes any type of computing device. FIG. 7 illustrates one embodiment of a computer system 720 that may be used to implement the above-described methods. As shown, computer system 720 includes a processor subsystem 703 (which may have a cache 714 in one embodiment) that is coupled to a memory 704, sound subsystem 705 and 110 interfaces(s) 701 via an interconnect 713 (e.g., a system bus). I/O interface(s) 701 is coupled to one or more I/O devices 702. Computer system 720 may be any of various types of devices, including, but not limited to, a personal computer system, desktop computer, laptop or notebook computer, mainframe computer system, hand-held computer, workstation, network computer, a consumer device such as a mobile phone, pager, or personal data assistant (PDA). Computer system 720 may also be any type of networked peripheral device such as storage devices, switches, modems, routers, etc. Although a single computer system 720 is shown in FIG. 7, system 720 may also be implemented as two or more computer systems operating together.

Processor subsystem 703 may include one or more processors or processing units. For example, processor subsystem 703 may include one or more multi-processor cores, each with its own internal communication and buses. In various embodiments of computer system 720, multiple instances of processor subsystem 703 may be coupled to interconnect 713. In various embodiments, processor subsystem 703 (or each processing unit within 703) may contain a cache 714 or other form of on-board memory.

Computer system 703 also contains memory 704 which is usable by processor subsystem 703. Memory 704 may be implemented using different physical memory media, such as hard disk storage, floppy disk storage, removable disk storage, flash memory, random access memory (SRAM, EDO RAM, SDRAM, DDR SDRAM, etc.), ROM (PROM, EEPROM, etc.), and so on.

As in FIG. 7, computer system 720 includes display adapter 706, monitor 707, keyboard 711 and mouse 712. Computer system 720 further includes storage subsystems such as a fixed disk 708 (e.g., hard drive), removable storage 709 (e.g., floppy or CD-ROM). Computer system 720 may include sound subsystem 705 (e.g. speakers), and network interface 710. Other computer systems suitable for use with the invention may include either additional or fewer subsystems.

I/O interfaces 701 may be any of various types of interfaces configured to couple to and communicate with other devices, according to various embodiments. In one embodiment, I/O interface 701 is a bridge chip from a front-side to one or more back-side buses.

I/O interfaces 701 may be coupled to one or more I/O devices 702 via one or more corresponding buses or other interfaces. Examples of I/O devices include storage devices (hard drive, optical drive, removable flash drive, storage array, storage area network, or their associated controller), network interface devices (e.g., to a local or wide-area network), or other devices (e.g., graphics, user interface devices, etc.)

Memory in computer system 720 is not limited to memory 704. Rather, computer system 720 may be said to have a “memory subsystem” that includes various types/locations of memory. For example, the memory subsystem of computer system 720 may, in one embodiment, include memory 704, cache 714 in processor subsystem 703, and storage on I/O Devices 702 (e.g., a hard drive, storage array, etc.), fixed disk 708 or removable disk 709 directly connected to interconnect bus. Thus, the phrase “memory subsystem” is representative of various types of possible memory media within computer system 720. In some embodiments, the memory subsystem includes program instructions executable by processor subsystem 720 to perform embodiments of the sequence similarity assessment algorithms of the present disclosure.

Various embodiments of the sequence similarity assessment algorithm (described above) may include storing instructions and/or data implemented in accordance with the foregoing description in an article of manufacture such as a tangible computer-readable memory medium, including various portions of the memory subsystem of computer system 720. Certain embodiments of these tangible computer-readable memory media may store instructions and/or data that are computer executable to perform actions in accordance with the present disclosure. Generally speaking, such an article of manufacture may include storage media or memory media such as magnetic (e.g., disk) or optical media (e.g., CD, DVD, BD, and related technologies, etc.). The article of manufacture may be either volatile or nonvolatile memory. For example, the article of manufacture may be (without limitation) SDRAM, DDR SDRAM, SRAM, SanDisk, flash memory, and of various types of ROM, etc.

Further embodiments may include signals such as electrical, electromagnetic, or optical signals, conveyed via a communication medium, link, and/or system (e.g., cable, network, etc.), whether wired, wireless or both. Such signals may carry instructions and/or data implemented in accordance with the foregoing description.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed by various described embodiments. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method of fast and accurate alignment of genomic sequences comprising:
building indices for reference sequence;
recording all local hits between a reference index and a query sequence in a local hit table;
identifying candidate entries in said local hits table for final alignment of said query sequence to said reference sequence;
decoding unmasked location of said hits in said reference sequence;
glueing said hits together by filling holes (no local hits) in said local hit table; and
reporting alignment result.

2. The method of fast and accurate alignment of genomic sequences of claim 1, wherein said reference indices comprising forward and backward indices.

3. The method of fast and accurate alignment of genomic sequences of claim 2, wherein
a forward index data structure is organized as a lexicographically sorted array of l base pairs prefixes;
each of said prefixes is pointing to a lexicographically sorted array of m base pairs suffixes;
each of said suffixes is associated with a numerically sorted array of l scaled k-bit masked locations of each of the l+m base pairs indexed entries, wherein k is distance mask size in bit; and
an optimal choice of l, m and k parameters depends on size and composition of said reference.

4. The method of fast and accurate alignment of genomic sequences of claim 2, wherein:
a backward index data structure is organized as a lexicographically sorted array of l base pairs prefixes;
each of said prefixes is pointing to a lexicographically sorted array of m base pairs suffixes;
each of said suffixes is associated with a numerically sorted array of l scaled k-bit masked locations of each of the l+m base pairs indexed entries, wherein k is distance mask size in bit; and
an optimal choice of l, m and k parameters depends on size and composition of said reference sequence.

5. The method of fast and accurate alignment of genomic sequences of claim 2, wherein when human genomic sequences are assessed, said l, m and k parameters are set as l=m =7 base pairs, and k=8 bit.

6. The method of fast and accurate alignment of genomic sequences of claim 2, wherein one forward index and two backward indices with gaps are built wherein, one said backward index is with a gap of l base pairs and the other said backward index is with a gap of 2l base pairs.

7. The method of fast and accurate alignment of genomic sequences of claim 2, wherein said forward or backward index work as a forward or backward tree to allow fast unwinding of low complexity regions and low error rate regions.

8. The method of fast and accurate alignment of genomic sequences of claim 1, wherein said local hit table is organized by a process comprising:
determining a hit's distance in a query;
determining said hit's distance in a reference;
determining a difference of said hit's distance in said query and distance in said reference;
filling said hit in said local hit table according to its distance in a query against said difference; and
the time complexity of said local hits table building depends linearly on the size of said query.

9. The method of fast and accurate alignment of genomic sequences of claim 8, wherein two local hits tables are built, one for said query and the other for its reverse complimentary sequence.

10. The method of fast and accurate alignment of genomic sequences of claim 8, wherein the entries with highest number of hits (max entries) in said local hit table are identified as candidates for final alignment of said query and said reference.

11. The method of fast and accurate alignment of genomic sequences of claim 8, wherein when the parameters are set as l=m=7 and k=8, a difference of at least 4 between the max entry (with highest number of hits) and second max entry rules out random hits and makes said max entry the candidate for final alignment.

12. The method of fast and accurate alignment of genomic sequences of claim 1, wherein when said hole is surrounded by the local hits with same difference between the query and the reference coordinates in said local hit table, said hole is filled with involvement of simple O(n) (n is the length of the hole, n<<q) transition through all bases in the hole.

13. The method of fast and accurate alignment of genomic sequences of claim 1, wherein when said hole is surrounded by the local hits with different values of the query and the reference coordinate differences, a gap of insertion is further introduced in the hole to allow the transition from the leftmost to the rightmost hits.

14. The method of fast and accurate alignment of genomic sequences of claim 1, wherein when said hole is surrounded by the local hits with different values of the query and the reference coordinate differences, a gap of deletion is further introduced in the hole to allow the transition from the leftmost to the rightmost hits.

15. The method of fast and accurate alignment of genomic sequences of claim 14, wherein
the size and type (deletion or insertion) of said gap are obtained from the local hit table; and
the position of said gap is obtained by iteratively using simulated annealing optimization with O(n) time complexity.

16. The method of fast and accurate alignment of genomic sequences of claim 15, wherein said optimization is implemented by a process comprising:
inserting said gap at an arbitrary position in said hole region of the query;
said gap moving freely anywhere in said hole region;
updating said gap's position under influence of attractive force acting on said gap from each mismatch site in the region; and
finding an optimal gap location.

17. The method of fast and accurate alignment of genomic sequences of claim 16, wherein said attractive force is controlled by parameters comprising:
annealing schedule, which is the rate and the pattern of increase or decrease in the mobility of the gap with respect to the same attractive force;
type of gap and mismatch interaction potential; and
effective gap mass.

18. The method of fast and accurate alignment of genomic sequences of claim 1, wherein said genomic sequences are DNA.

19. The method of fast and accurate alignment of genomic sequences of claim 1, wherein said genomic sequences are RNA.

20. The method of fast and accurate alignment of genomic sequences of claim 1, wherein said genomic sequences are human genomic sequences.

21. The method of fast and accurate alignment of genomic sequences of claim 1, wherein said method is implemented in a computational system.

22. The method of fast and accurate alignment of genomic sequences of claim 1, wherein said method is implemented with GPU or FPGA.
